(19) United States
(12) Patent Application Publication
(10) Pub. No.: US 2022/0163007 A1
(43) Pub. Date: May 26, 2022

(54) SINGLE-INLET AIR INTAKE CONTROL STRUCTURE

(71) Applicant: AEON MOTOR CO., LTD., Tainan City (TW)

(72) Inventors: Hui-Hui HUANG, Tainan City (TW); Ching-Hsiung TUNG, Tainan City (TW); Ming-Ze WENG, Tainan City (TW)

(73) Assignee: AEON MOTOR CO., LTD., Tainan City (TW)

(21) Appl. No.: 17/329,265

(22) Filed: May 25, 2021

(30) Foreign Application Priority Data
Nov. 25, 2020 (TW) 109141381

(51) Int. Cl. F02M 35/10; F02M 35/16

(52) U.S. Cl. CPC F02M 35/10209; F02M 35/162

(57) ABSTRACT

A single-inlet air intake control structure is connected to an engine of a power system and regulates the intake air quantity of the engine. The single-inlet air intake control structure comprises an air cleaner, a control valve, a throttle valve, a first pipe and a second pipe. The first pipe connects the air cleaner and the control valve. The second pipe connects the control valve and the throttle valve. The air cleaner, the first pipe, the control valve, the second pipe and the throttle valve are connected to form an air intake passage. By structural simplifying, the single-inlet air intake control structure controls the air intake passage within an appropriate length range and thus can lower the cost. Furthermore, the single-inlet air intake control structure can directly regulate the intake air quantity of the engine when the engine operates at either a high or a low speed.

### BACKGROUND OF THE INVENTION

### 1. Field of the Invention

The present invention relates to a single-inlet air intake control structure applied to power systems such as a motorcycle with an engine, especially to a single-inlet air intake control structure that can regulate the intake air according to the variation of the engine speed.

### 2. Description of the Prior Arts

In conventional power systems such as a motorcycle with an engine, in order to generate energy to operate the engine, fuel such as gas of an aspirated engine is required to be properly mixed with external air for combustion. Besides, the intake air quantity also needs to be regulated according to variations of the engine speed. Therefore, the power systems are all equipped with an intake air control structure. The conventional air intake control structures include the following two configurations.

One of the configurations of the variable air intake structure is to dispose an intake manifold between an air cleaner and a variable intake actuator. The intake manifold includes a high-speed pipe with a larger sectional area and a low-speed pipe with a smaller sectional area. One end of the high-speed pipe is connected to the variable intake actuator and the other end of the high-speed pipe is connected to the air cleaner. A controllable rotary gate valve is mounted in the high-speed pipe. One end of the low-speed pipe is connected to the high-speed pipe in a position between the rotary gate valve of the high-speed pipe and the variable intake actuator. The other end of the low-speed pipe is connected to the air cleaner. The variable air intake structure is a dual-inlet structure. By connecting the air cleaner to the high-speed pipe at a position between the rotary gate valve and the variable intake actuator via the low-speed pipe, when the engine speed is low, the external air can be directly supplied to the engine through the air cleaner, the low-speed pipe and the variable intake actuator. In addition, when the engine speed is high, the intake air quantity can be increased by regulating the rotary gate valve of the high-speed pipe.

The above-mentioned variable air intake structure can use the dual-inlet structure to regulate the intake air, and thus the intake air quantity can be regulated to correspond to the variations of the engine speed. However, the construction of the above-mentioned dual-inlet variable air intake structure is rather complicated and the assembling is time-consuming, causing high cost.

Furthermore, in the above-mentioned intake air control structure, the external air always can be directly applied to the engine through the air cleaner, the low-speed pipe and the variable intake actuator, but the rotary gate valve of the high speed pipe can be regulated to increase the intake air quantity when the engine speed is high. However, even though using the other inlet (high speed pipe) to indirectly regulate the intake air quantity, the regulating effects of the two inlets (high speed pipe and low speed pipe) are both affected by variations of the air pressure of the original intake air control structure. In addition, both the low-speed pipe and the high-speed pipe are connected to the air cleaner, such that the resistance caused by air through an air filter in the air cleaner may hinder precision of regulating the total intake air quantity.

The other configuration of the variable air intake structure is mainly composed by an inlet pipe, an air storage space, an outlet pipe, a control valve and a bypass air storage space. Both the inlet pipe and the outlet pipe are connected to the air storage space, and the external air flows into the engine through the inlet pipe, the air storage space and the outlet pipe. The bypass air storage space is connected to the air storage space by the control valve, and the control valve can be open or closed based on the engine speed.

The other configuration of the above-mentioned variable air intake structure is yet a dual-inlet structure, and increases the intake air quantity by another inlet passage (bypass air storage space) of the variable air intake structure to enhance the performance that reacts to the variations of the engine speed. However, the above-mentioned dual-inlet variable air intake structure has yet the problems such as the complicated construction, the highly time-consuming assembly and the high cost.

Furthermore, the other configuration of the above-mentioned variable air intake structure is based on the path that the external air flows into the engine from the inlet pipes, through the air storage space and the outlet pipe. The variable air intake structure uses the bypass air storage space to change the intake air quantity entering the air storage space by the control valve to regulate the total intake air quantity of the engine. This indirect way to regulate intake air quantity may be affected by the variations of the air pressure in the intake air control structure. In addition, both the inlet pipe and the bypass air storage space are connected to the air storage space respectively, and an air filter is mounted in the air storage space, such that the resistance caused by air through the air filter in the air storage space may hinder precision of regulating the total intake air quantity.

### SUMMARY OF THE INVENTION

The technical problems that the present invention wants to solve are that the construction of the dual-inlet air intake control structure is complicated, the assembling is time-consuming, the cost is high, and the dual-inlet air intake control structure occupies much space. In addition, the way to control the total intake air quantity is indirect. Thus, the present invention also wants to solve the problem that both the inlet passages are connected to the air cleaner, which hinders precision of regulating the total intake air quantity.

A single-inlet air intake control structure of the present invention comprises an air cleaner, a control valve, a throttle valve, a first pipe and a second pipe. The air cleaner has a cleaner shell and an air filter, the air filter disposed at an interior of the cleaner shell. The cleaner shell has an air inlet at one side of the air filter, and the cleaner shell has an air outlet at another side of the air filter. The control valve is disposed at one side of the air cleaner. The control valve has a valve shell and a control valve gate, and the control valve gate is disposed in the valve shell and is rotatable to be open or closed. The throttle valve is disposed at one side, which is opposite to the air cleaner, of the control valve. The throttle valve has a throttle body and a throttle valve gate, and the throttle valve gate is disposed in the throttle body and is rotatable to be open or closed. The first pipe connects the air outlet of the air cleaner and the control valve. The second pipe connects the control valve and the throttle valve, and thus the throttle valve, the second pipe, the control valve, the first pipe and the air cleaner are connected to form an air intake passage.

The main objective of the present invention is to form an air intake passage by connecting the throttle valve, the second pipe, the control valve, the first pipe and the air cleaner in sequence, and the present invention applies the air intake passage to a power system with an engine to provide the right quantity of air during the operation of the engine at high engine speeds or at low engine speeds. By this simplified single-inlet air intake control structure, the present invention can increase the convenience of assembling, save space, and control the air intake passage within an appropriate length range to lower the cost.

On the other hand, the single-inlet air intake control structure in accordance with the present invention directly controls the intake air quantity through the throttle valve and the control valve, which are respectively at the appropriate positions of the air intake passage. When the engine is operating at high engine speeds, a higher intake air quantity is required. At this time, the throttle valve is switched to a full-open or a wide-open state, and thus the intake air can be applied to the engine directly through the air cleaner, the first pipe, the control valve, the second pipe and the throttle valve. Besides, the control valve is switched to be nearly closed, and thus the engine speed can be decreased. On the contrary, when the engine is operating at low engine speeds, a lower intake air quantity is required. At this time, the throttle valve is switched to a nearly-closed state, that is, the throttle valve is switched to a narrow-open state. Therefore, switching the control valve to open can provide the engine with the intake air quantity that the engine requires.

### BRIEF DESCRIPTION OF THE DRAWINGS

FIG. 1 is a perspective view of a single-inlet air intake control structure in accordance with the present invention;

FIG. 2 is an another perspective view of the single-inlet air intake control structure in FIG. 1;

FIG. 3 is an exploded perspective view of the single-inlet air intake control structure in FIG. 1;

FIG. 4 is a top view of the single-inlet air intake control structure in FIG. 1;

FIG. 5 is a partial sectional view along line A-A in FIG. 4;

FIG. 6 is a front view of the single-inlet air intake control structure in FIG. 1; and

FIG. 7 is a partial sectional view along line B-B in FIG. 6.

### DETAILED DESCRIPTION OF THE PREFERRED EMBODIMENTS

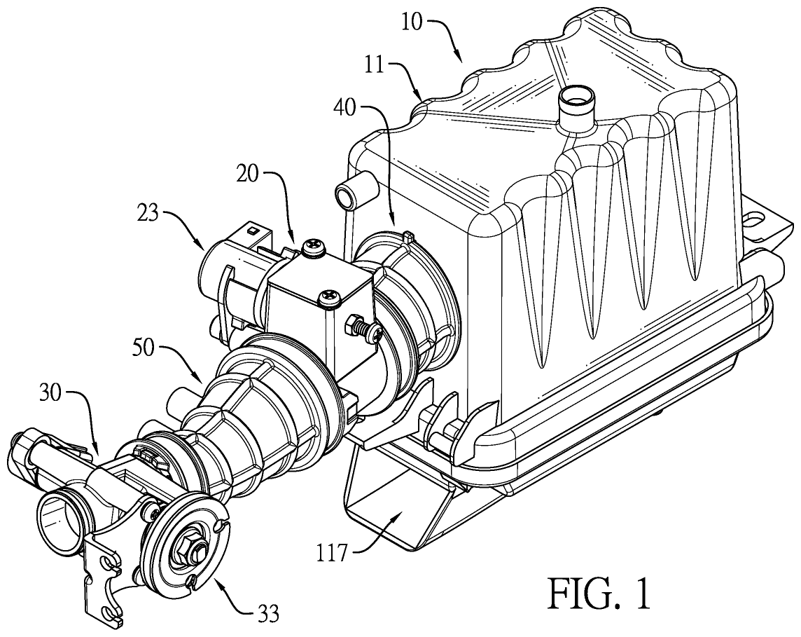

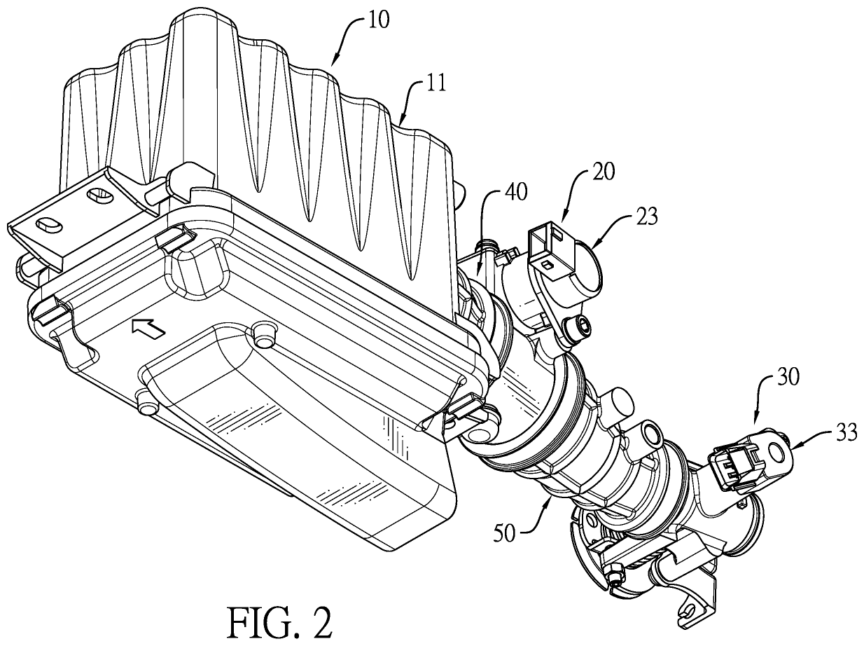

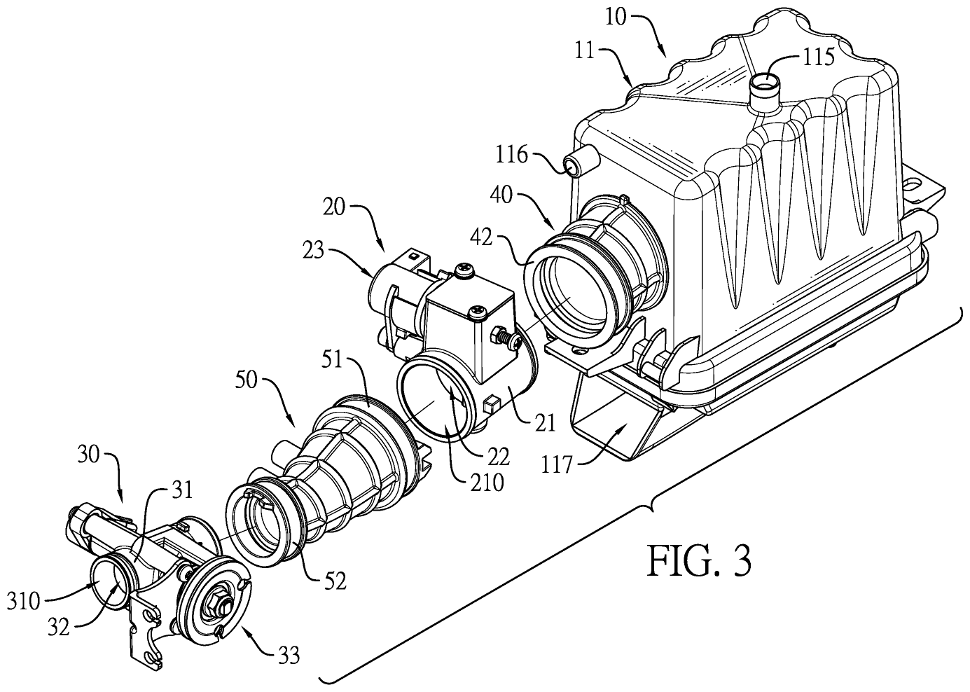

FIGS. 1 to 3 are various connecting configurations of a single-inlet air intake control structure in accordance with the present invention. The single-inlet air intake control structure comprises an air cleaner 10, a control valve 20, a throttle valve 30, a first pipe 40 and a second pipe 50.

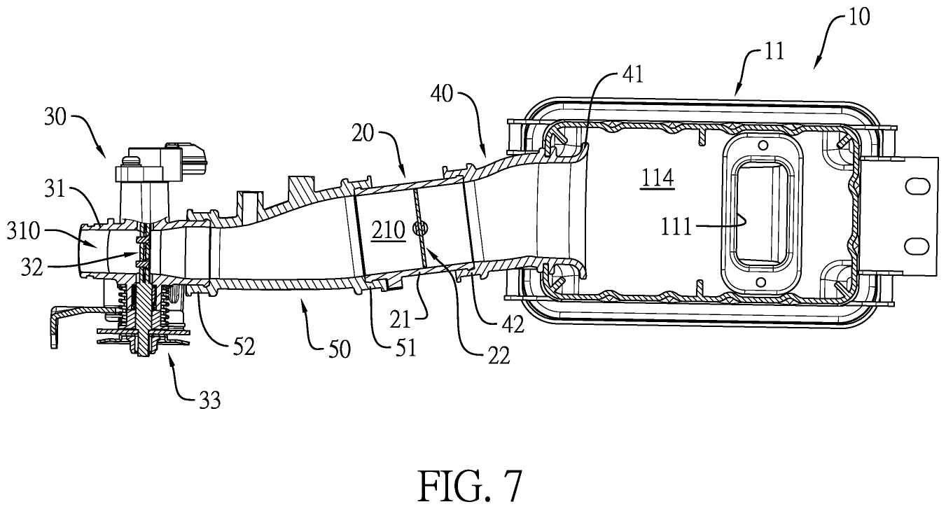

With reference to FIGS. 1 to 3, 5 and 7, the air cleaner 10 comprises a cleaner shell 11 and an air filter 12. The cleaner shell 11 has an interior space and is a detachable structure. An air inlet 111 and an air outlet 112 are respectively formed at different positions of the cleaner shell 11. The air filter 12 is an element that has the functions such as filtering out the dust in the air, etc., and the air filter 12 is a conventional product. The air filter 12 is disposed in the interior space of the cleaner shell 11 and divides the interior space of the cleaner shell 11 into a first zone 113 and a second zone 114. The air inlet 111 is connected to the first zone 113, and the air outlet 112 is connected to the second zone 114. External air can flow into the first zone 113 from the air inlet 111 of the cleaner shell 11, through the air filter 12 to have the dust filtered away, and afterwards the purified air enters the second zone 114 and is discharged through the air outlet 112. In a preferred embodiment, an air scoop is mounted on an outer wall of the cleaner shell 11, and an interior of the air scoop has an extended air inlet passage 117 connected to the air inlet 111.

Besides, with reference to FIGS. 1 to 3, 5 and 7, at least one through hole is formed through the outer wall of the cleaner shell 11 and connected to the second zone 114. In a preferred embodiment, the at least one through hole includes a drainage hole 115 and an engine breather intake hole 116 at different positions of the outer wall of the cleaner shell 11, and both the drainage hole 115 and the engine breather intake hole 116 are connected to the cleaner shell 11 to the second zone 114. In a preferred embodiment, the drainage hole 115 and the engine breather intake hole 116 are at different side walls of the cleaner shell 11. The above-mentioned drainage hole 115 and the engine breather intake hole 116 are the structures that most conventional air cleaners have, and thus descriptions of the functions of the drainage hole 115 and the engine breather intake hole 116 are omitted.

With reference to FIGS. 1 to 3, 5 and 7, the control valve 20 is disposed at one side of the air cleaner 10 and has a valve shell 21 and a control valve gate 22. A control valve passage 210 is formed within the valve shell 21. The control valve gate 22 is disposed in the valve shell 21, and the control valve gate 22 can be rotated to open or to close the control valve passage 210. A control unit 23 is disposed on the valve shell 21. An angle of the control valve gate 22 can be changed by the control unit 23. The control unit 23 can be chosen from conventional products, and thus description of the structure of the control unit 23 is omitted.

With reference to FIGS. 1 to 3, 5 and 7, the throttle valve 30 is disposed at one side, which is opposite to the air cleaner 10, of the control valve 20. The throttle valve 30 has a throttle body 31 and a throttle valve gate 32. A throttle valve passage 310 is formed within the throttle body 31. The throttle valve gate 32 is disposed in the throttle body 31, and the throttle valve gate 32 can be rotated to open or to close the throttle valve passage 310. A throttle control unit 33 is disposed on the throttle body 31. An angle of the throttle valve gate 32 can be changed by the throttle control unit 33. The throttle control unit 33 can be chosen from conventional products, and thus description of the structure of the throttle control unit 33 is omitted.

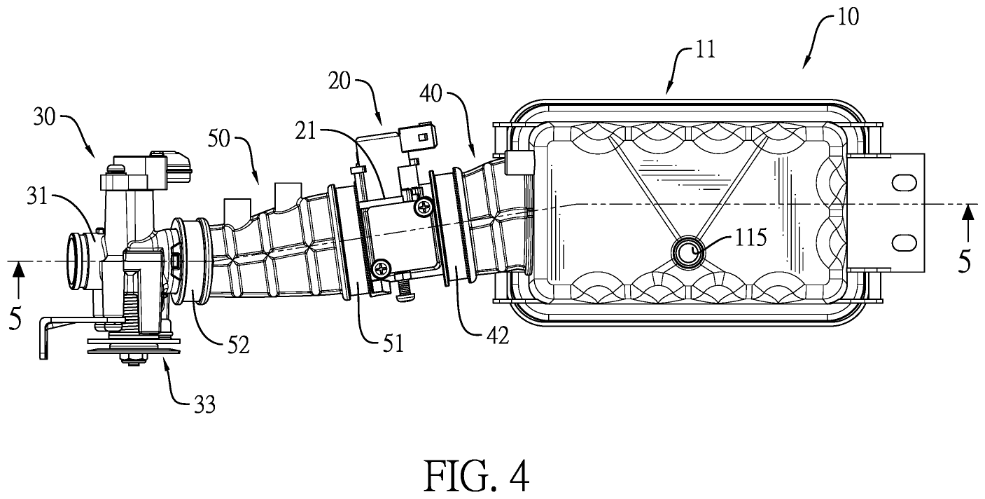

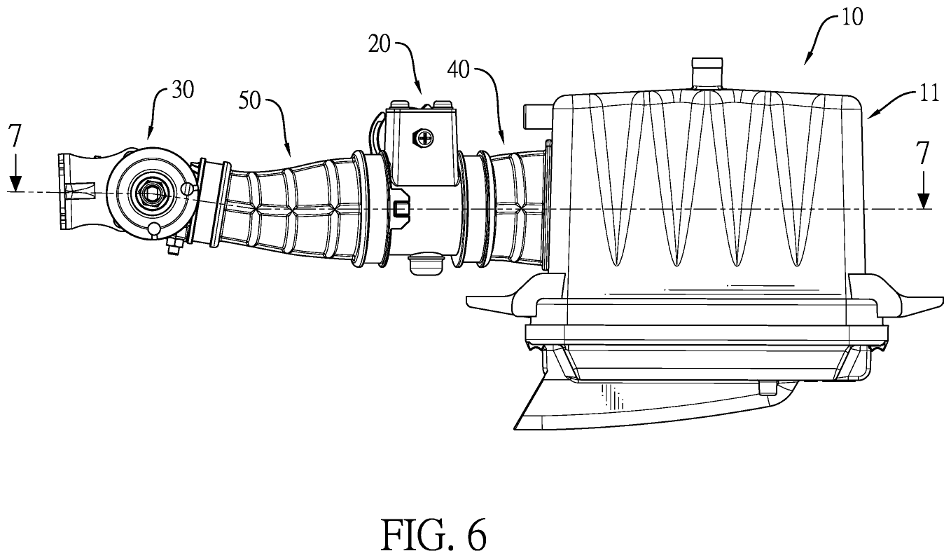

With reference to FIGS. 4 to 7, the first pipe 40 connects the air cleaner 10 and the control valve 20. One end of the first pipe 40 is defined as a first pipe end 41, and the other end of the first pipe 40 is defined as a second pipe end 42. The first pipe 40 is connected to the second zone 114 of the cleaner shell 11 through installing the first pipe end 41 to the air outlet 112 of the cleaner shell 11. The first pipe 40 is then connected to one end of the control valve passage 210 of the control valve 20 through the second pipe end 42.

With reference to FIGS. 4 to 7, the second pipe 50 connects the control valve 20 and the throttle valve 30. One end of the second pipe 50 is defined as a first end 51, and the other end of the second pipe 50 is defined as a second end 52. The second pipe 50 is connected to one end of the control valve passage 210 of the control valve 20 through the first end 51. The second pipe 50 is then connected to one end of the throttle valve passage 310 of the throttle valve 30 through the second end 52. Thus the throttle valve 30, the second pipe 50, the control valve 20, the first pipe 40 and the air cleaner 10 are connected in sequence to form an air intake passage.

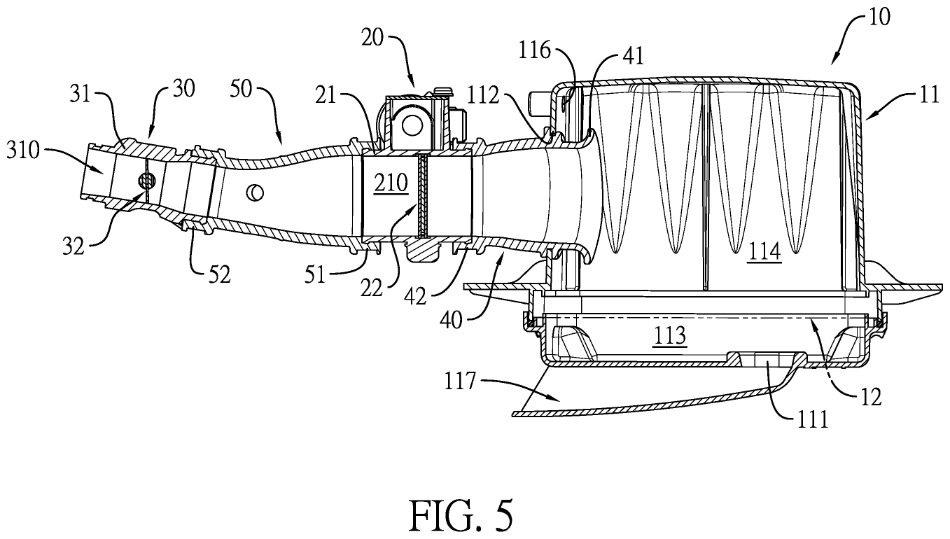

With reference to FIGS. 5 to 7, in a preferred embodiment, a sectional area of the first pipe 40 gradually decreases from the first pipe end 41 to the second pipe end 42. Thus, when air flows from the first pipe end 41 to the second pipe end 42, the air speed increases. A sectional area of the second pipe 50 gradually decreases from the first end 51 to the second end 52. A sectional area of the first end 51 of the second pipe 50 is equal or approximate to a sectional area of the second pipe end 42 of the first pipe 40. A sectional area of one end, which is adjacent to the second end 52 of the second pipe 50, of the throttle valve passage 310 of the throttle valve 30 is larger than a sectional area of the other end of the throttle valve passage 310. Thus, in the throttle valve passage 310 of the throttle valve 30, when air flows from the end adjacent to the second end 52 of the second pipe 50 to the other end, the air speed increases.

The single-inlet air intake control structure in accordance with the present invention can be applied to power systems such as a motorcycle with an engine, etc. With reference to FIGS. 1, 2, 5 and 7, the single-inlet air intake control structure is connected to the engine by the throttle valve 30. When the engine is operating, the required intake air quantity is brought by the negative pressure effect caused by the air intake passage within the single-inlet air intake control structure. The intake air then is mixed with the fuel such as gas and then is injected into the engine. The single-inlet air intake control structure in accordance with the present invention directly controls the intake air quantity of the engine mainly through the throttle valve 30 and the control valve 20 respectively at the appropriate positions of the air intake passage.

When the engine speed is high, a higher intake air quantity is required. At this time, the throttle valve 30 is switched to a full-open or a wide-open state, and thus the intake air can be applied to the engine directly through the air cleaner 10, the first pipe 40, the control valve 20, the second pipe 50 and the throttle valve 30. Besides, the control valve 20 is switched to be nearly closed, and thus the engine speed can be decreased, thereby limiting the engine speed.

When the engine speed is low, a lower intake air quantity is required. At this time, the throttle valve 30 is switched to a nearly-closed state, that is, the throttle valve 30 is switched to a narrow-open state. Therefore, switching the control valve 20 to open can provide the engine the intake air quantity that the engine requires.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A single-inlet air intake control structure comprising:
an air cleaner having
a cleaner shell;
an air filter disposed at an interior of the cleaner shell, and the cleaner shell having
an air inlet at one side of the air filter;
an air outlet at another side of the air filter;
a control valve disposed at one side of the air cleaner and having
a valve shell; and
a control valve gate disposed in the valve shell, and being rotatable to be open or closed;
a throttle valve disposed at one side, which is opposite to the air cleaner, of the control valve and having
a throttle body; and
a throttle valve gate disposed in the throttle body, and being rotatable to be open or closed;
a first pipe connecting the air outlet of the air cleaner and the control valve; and
a second pipe connecting the control valve and the throttle valve, and thus the throttle valve, the second pipe, the control valve, the first pipe and the air cleaner connected to form an air intake passage.

2. The single-inlet air intake control structure as claimed in claim 1, wherein the air filter divides the interior of the cleaner shell into
a first zone; the air inlet connected to the first zone; and
a second zone; the air outlet connected to the second zone, and at least one through hole formed through an outer wall of the cleaner shell and connected to the second zone.

3. The single-inlet air intake control structure as claimed in claim 1, wherein
one end of the second pipe is defined as a first end, and the first end is connected to the control valve;
another end of the second pipe is defined as a second end, and the second end is connected to the throttle valve; and
a sectional area of the second pipe gradually decreases from the first end to the second end.

4. The single-inlet air intake control structure as claimed in claim 2, wherein
one end of the second pipe is defined as a first end, and the first end is connected to the control valve;
another end of the second pipe is defined as a second end, and the second end is connected to the throttle valve; and
a sectional area of the second pipe gradually decreases from the first end to the second end.

5. The single-inlet air intake control structure as claimed in claim 1, wherein
one end of the first pipe is defined as a first pipe end, and the first pipe end is disposed at the air outlet of the cleaner shell;
another end of the first pipe is defined as a second pipe end, and the second pipe end is connected to the control valve; and
a sectional area of the first pipe gradually decreases from the first pipe end to the second pipe end.

6. The single-inlet air intake control structure as claimed in claim 2, wherein
one end of the first pipe is defined as a first pipe end, and the first pipe end is disposed at the air outlet of the cleaner shell;
another end of the first pipe is defined as a second pipe end, and the second pipe end is connected to the control valve; and
a sectional area of the first pipe gradually decreases from the first pipe end to the second pipe end.

7. The single-inlet air intake control structure as claimed in claim 3, wherein
one end of the first pipe is defined as a first pipe end, and the first pipe end is disposed at the air outlet of the cleaner shell;
another end of the first pipe is defined as a second pipe end, and the second pipe end is connected to the control valve; and
a sectional area of the first pipe gradually decreases from the first pipe end to the second pipe end.

8. The single-inlet air intake control structure as claimed in claim 4, wherein
one end of the first pipe is defined as a first pipe end, and the first pipe end is disposed at the air outlet of the cleaner shell;
another end of the first pipe is defined as a second pipe end, and the second pipe end is connected to the control valve; and
a sectional area of the first pipe gradually decreases from the first pipe end to the second pipe end.

9. The single-inlet air intake control structure as claimed in claim 1, wherein an air scoop is mounted on an outer wall of the cleaner shell, and has
an extended air inlet passage disposed in an interior of the air scoop and connected to the air inlet.

10. The single-inlet air intake control structure as claimed in claim 2, wherein an air scoop is mounted on the outer wall of the cleaner shell, and has
an extended air inlet passage disposed in an interior of the air scoop and connected to the air inlet.

11. The single-inlet air intake control structure as claimed in claim 3, wherein an air scoop is mounted on an outer wall of the cleaner shell, and has
an extended air inlet passage disposed in an interior of the air scoop and connected to the air inlet.

12. The single-inlet air intake control structure as claimed in claim 4, wherein an air scoop is mounted on the outer wall of the cleaner shell, and has
an extended air inlet passage disposed in an interior of the air scoop and connected to the air inlet.

13. The single-inlet air intake control structure as claimed in claim 5, wherein an air scoop is mounted on an outer wall of the cleaner shell, and has
an extended air inlet passage disposed in an interior of the air scoop and connected to the air inlet.

14. The single-inlet air intake control structure as claimed in claim 6, wherein an air scoop is mounted on the outer wall of the cleaner shell, and has
an extended air inlet passage disposed in an interior of the air scoop and connected to the air inlet.

15. The single-inlet air intake control structure as claimed in claim 7, wherein an air scoop is mounted on an outer wall of the cleaner shell, and has
an extended air inlet passage disposed in an interior of the air scoop and connected to the air inlet.

16. The single-inlet air intake control structure as claimed in claim 8, wherein an air scoop is mounted on the outer wall of the cleaner shell, and has
an extended air inlet passage disposed in an interior of the air scoop and connected to the air inlet.
